(19) United States
(12) Patent Application Publication
(10) Pub. No.: US 2026/0202269 A1
(43) Pub. Date: Jul. 16, 2026

(54) APPARATUS FOR FORCE MEASUREMENT

(71) Applicant: Infineon Technologies AG, Neubiberg (DE)

(72) Inventors: Horst THEUSS, Wenzenbach (DE); Thomas MÜLLER, Lappersdorf (DE); Andreas ALLMEIER, Pfatter (DE); Klaus ELIAN, Alteglofsheim (DE)

(21) Appl. No.: 19/426,443

(22) Filed: Dec. 19, 2025

(30) Foreign Application Priority Data
Jan. 15, 2025 (DE) 102025101331.4

(51) Int. Cl. G01L 1/14

(52) U.S. Cl. CPC G01L 1/148

(57) ABSTRACT

An apparatus for force measurement includes a cavity package and a pressure sensor arranged in the cavity package. Additionally, the apparatus includes a first material and a second material arranged in the cavity package. The first material encloses the pressure sensor. The second material covers the first material, exhibits a higher Young's modulus than the first material, and is configured to transfer an external force applied to the second material to the first material. The pressure sensor is configured to measure pressure within the first material resulting from the external force.

### CROSS-REFERENCE TO RELATED APPLICATION

This application claims priority to Germany Patent Application No. 102025101331.4 filed on Jan. 15, 2025, the content of which is incorporated by reference herein in its entirety.

### TECHNICAL FIELD

The present disclosure relates to force measurement. In particular, examples of the present disclosure relate to an apparatus for force measurement.

### BACKGROUND

Force measurement is an important aspect in various fields, including automotive, industrial, medical and consumer applications. Traditional force sensors often require complex structures or additional mechanical components to achieve accurate measurements. These designs result in higher manufacturing costs, larger device sizes, and challenges in integration into compact systems. Additionally, conventional sensors may face limitations in robustness or reliability under varying environmental conditions, such as temperature fluctuations or mechanical impacts.

Hence, there may be a demand for improved force measurement.

### SUMMARY

This demand is met by the subject-matter of the independent claim. Advantageous implementations are addressed by the dependent claims.

According to an aspect, the present disclosure provides an apparatus for force measurement. The apparatus comprises a cavity package and a pressure sensor arranged in the cavity package. Additionally, the apparatus comprises a first material and a second material arranged in the cavity package. The first material encloses the pressure sensor. The second material covers the first material, exhibits a higher Young's modulus than the first material, and is configured to transfer an external force applied to the second material to the first material. The pressure sensor is configured to measure pressure within the first material resulting from the external force.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a first example of an apparatus for force measurement;

FIG. 2 illustrates a second example of an apparatus for force measurement;

FIG. 3 illustrates a third example of an apparatus for force measurement;

FIG. 4 illustrates a fourth example of an apparatus for force measurement;

FIG. 5 illustrates a fifth example of an apparatus for force measurement;

FIGS. 6A and 6B illustrate a sixth example of an apparatus for force measurement; and

FIGS. 7A and 7B illustrate a seventh example of an apparatus for force measurement.

### DETAILED DESCRIPTION

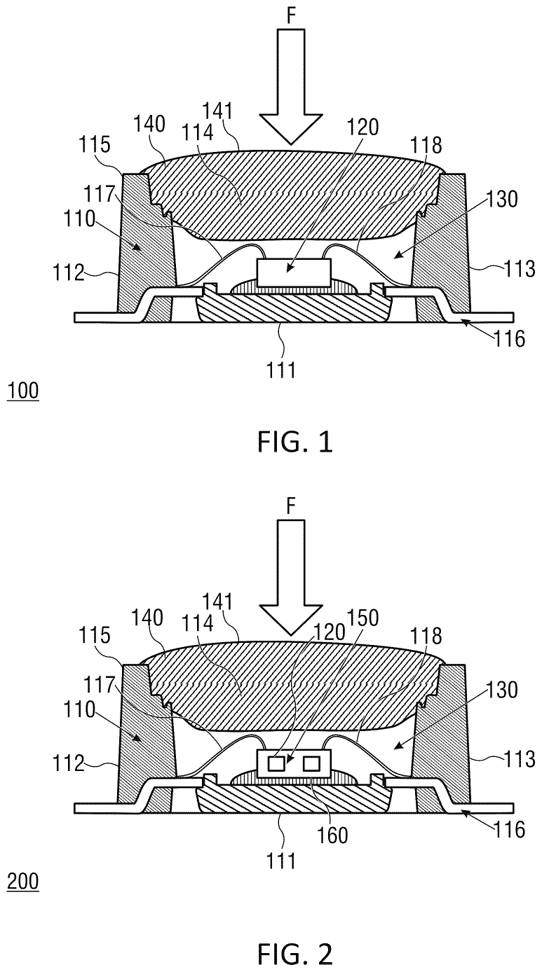

FIG. 1 schematically illustrates a section view of an apparatus 100 for force measurement.

The apparatus 100 comprises a cavity package 110. The cavity package 110 serves as a structural housing for further components of the apparatus 100, providing mechanical support and environmental protection. The cavity package 110 comprises a base 111 and sidewalls 112, 113 forming a partially enclosed space to securely hold further components of the apparatus 100. In other words, the base 111 and the sidewalls 112, 113 define an internal cavity 114 where these components are arranged. The internal cavity 114 is accessible from outside the cavity package 110 as the cavity package 110 does not fully enclose the internal cavity 114. The cavity package 110 may be made from various materials such as one or more of plastics, ceramics, or metals to provide various properties such as, e.g., thermal stability, mechanical strength, and resistance to environmental factors like humidity or chemical exposure. For example, the cavity package 110 may be made from epoxy-based material or thermoplastic material like PolyPhenyleneSulfide (PPS), PolyStyrene (PS), PolyPropylene (PP), PolyCarbonate (PC), PolyButyleneSuccinate (PBS), or Liquid Crystal Polymer (LCP). In other examples, the cavity package 110 may be made from thermoset material or foamed plastic material. In some examples, the cavity package 110 may be made from a mixture of two or more of the aforementioned materials. It should be noted that the present disclosure is not limited to the aforementioned materials - other suitable materials may be used instead or additionally for the cavity package 110.

The apparatus 100 further comprises a pressure sensor 120. The pressure sensor 120 is arranged in the cavity package 110. For example, the pressure sensor 120 may be arranged (formed) on the base 111 of the cavity package 110. The pressure sensor 120 may use any known physical principle to detect and measure pressure. For example, the pressure sensor 120 may be a capacitive pressure sensor or a piezoelectric pressure sensor. According to examples of the present disclosure, the pressure sensor 120 may be a micromachined pressure sensor such as a Capacitive Micromechanical Ultrasonic Transducer (CMUT) or a Piezoelectric Micromechanical Ultrasonic Transducer (PMUT). It should be noted that the present disclosure is not limited to the aforementioned types of pressure sensors - other suitable types of pressure sensors may be used alternatively.

Additionally, the apparatus 100 comprises a first material 130 and a second material 140 arranged in the cavity package 110. The first material 130 encloses the pressure sensor 120. The second material 140 covers the first material 130 as illustrated in FIG. 1. The second material 140 exhibits a higher Young's modulus than the first material 130, and is configured to transfer an external force F applied to the second material 140 to the first material 130. The pressure sensor 120 is configured to measure pressure within the first material 130 resulting from the external force F.

The first material 130 is a compliant medium that encloses the pressure sensor 120. Its primary function is to transfer the external force F applied to the second material 140 into a measurable pressure that is sensed by the pressure sensor 120. The first material 130 is selected for its ability to deform under applied force while maintaining consistent pressure transfer properties. The first material 130 has a relatively low Young's modulus (e.g., 1 to 20 Mpa or less), making it softer and more deformable compared to the second material 140. This ensures effective pressure transmission to the pressure sensor 120. For example, the first material 130 may be a gel, such as a silicone-based and/or epoxy-based gel, or alternatively a fluid. The first material 130 may be chosen based on various factors such as application requirements, operating temperature ranges, and desired pressure transfer characteristics.

The second material 140 is a more rigid medium that (fully) covers the first material 130 and interfaces with the external force F. Its primary function is to receive the external force F and transfer it to the first material 130. The second material 140 also provides mechanical protection for the first material 130, ensuring durability under applied forces. The second material 140 has a higher Young's modulus than the first material 130, ensuring it can withstand higher stresses and effectively transfer force to the first material 130. For example, the second material 140's Young's modulus may be at least twice that of the first material 130 (e.g., 2 to 100 times the Young's modulus of the first material 130). The second material 140 may also be a gel, but with greater rigidity than the first material 130. This difference in mechanical properties allows for the accurate transfer of force. The second material 140 may be selected to show good adhesion to the cavity package 110 and not delaminate during mechanical load cycles.

The first material 130 and the second material 140 may exhibit a lower Young's modulus than the (material of the) cavity package 110. For example, the (material of the) cavity package 110 may exhibit a Young's modulus that is at least 10, 20, 50 or 100 times higher than that of the second material 140.

The combination of the first and second materials 130, 140 enables efficient force transfer to the pressure sensor 120 while maintaining structural integrity. The use of the soft first material 130 and the more rigid second material 140 ensures that the external force F is effectively transferred to the pressure sensor 120. This layered configuration enhances the sensitivity and precision of the pressure measurement. The first material 130, being soft or fluid-like, allows deformation under the applied force F, enabling accurate pressure distribution to the pressure sensor 120. The second material 140, being more rigid, protects the first material 130 and provides a robust interface for force application. This combination allows for customizable material choices depending on the application requirements. The use of the cavity package 110 to house the pressure sensor 120 and the materials 130, 140 results in a compact, integrated structure. This reduces the overall size of the apparatus 100, making it suitable for applications where space constraints are critical, such as in automotive or medical devices. The cavity package 110 encapsulates and protects the pressure sensor 120 and other internal components from environmental factors such as dust, moisture and mechanical shocks, ensuring reliable operation even in harsh conditions. The second material 140's higher Young's modulus not only aids in force transfer but also acts as a protective layer for the softer first material 130, increasing the apparatus 100's durability under repeated use or high forces. The apparatus 100 is suitable for a wide range of applications, including automotive (e.g., touch panels, impact sensors), industrial (e.g., load sensing, robotic end-effectors), and medical (e.g., infusion pumps, pressure monitoring). The versatility of the design makes it adaptable to various use cases. By leveraging simple materials such as gels and integrating the pressure sensor 120 within the cavity package 110, the apparatus 100 achieves a cost-effective solution compared to traditional force measurement systems that rely on more complex mechanical structures or expensive materials. The apparatus 100 may be tailored for specific pressure ranges by adjusting the material properties (e.g., Young's modulus of the first and second materials 130 and 140).

The first material 130 may, e.g., deform isotropically, creating a uniform pressure distribution under the external force F applied to the second material 140. In other words, the first material 130 may be configured to create an isotropic pressure distribution within its volume when the external force F is applied. The isotropic pressure distribution ensures that the force applied F to the second material 140 is uniformly transmitted through the first material 130 to the pressure sensor 120. This uniformity reduces measurement errors and improves the reliability of the force measurement. By distributing pressure evenly, the first material 130 minimizes localized stress concentrations or distortions that could affect the output of the pressure sensor 120. This leads to more accurate and consistent readings.

The second material 140 may take various shapes. For example, as illustrated in FIG. 1, the second material 140 may form a convex surface 141 extending above a rim 115 of the cavity package 110. The rim 115 is to the upper boundary or edge of the cavity package 110 that defines the transition between the internal cavity 114 of the cavity package 110 and its external environment. A convex surface allows the second material 140 to concentrate and direct the applied external force F more effectively to the first material 130. This ensures efficient and predictable force transfer to the pressure sensor 120. The convex shape provides a well-defined interface for engaging with force applicators, such as pressable tools or external objects. This ensures consistent application of force over the desired area. The convex geometry helps ensure that the force F applied to the second material 140 is distributed evenly into the first material 130. This uniform pressure distribution improves the accuracy and consistency of the pressure sensor 120's measurements. However, it should be noted that the present disclosure is not limited thereto.

In alternative examples, the second material 140 may form a flat surface that is substantially level with the rim 115 of the cavity package 110. A flat surface provides a uniform and predictable interface for applying the external force F. This ensures consistent transmission of the force to the first material 130 and subsequently to the pressure sensor 120. A flat surface is straightforward to manufacture and integrate, reducing the complexity of the second material 140's geometry and simplifying the overall production process.

In still other examples, the second material 140 may form a concave surface that dips below the rim 115 of the cavity package 110. A concave surface positions the second material 140 below the rim 115 of the cavity package 110. The concave geometry helps guide external force applicators, such as pressing tools or rounded objects, to the optimal position on the second material 140. This self-centering effect ensures consistent and predictable force application.

Also the first material 130 may take various shapes. For example, as illustrated in FIG. 1, the first material 130 may form a convex surface that is entirely covered by the second material 140. The convex shape of the first material 130 optimizes the distribution of the external force F applied through the second material 140. This ensures efficient and uniform pressure transfer to the pressure sensor 120, improving measurement accuracy. By entirely covering the convex surface of the first material 130 with the second material 140, the design provides a protective layer. This shields the first material 130 from direct contact with external forces, environmental contaminants, or mechanical impacts, enhancing durability and reliability. However, it should be noted that the present disclosure is not limited thereto. In alternative examples, the first material 130 may form a flat surface or a convex surface that is entirely covered by the second material 140.

In the example of FIG. 1, the cavity package 110 comprises a leadframe 116 that is electrically coupled to the pressure sensor 120. The pressure sensor 120 is electrically contacted via one or more bonding wires, as indicated in FIG. 1 by the bonding wires 117 and 118 between the pressure sensor 120 and the leadframe 116. Additional electrical elements or components arranged in the cavity package 110 may be electrically coupled to the leadframe 116 in a similar manner via bonding wires. Other contacting means or flipchip bonding can be employed as an alternative to wire bonding. Contacts of the leadframe 116 are routed (e.g., laterally) out of the cavity package 110 such that the pressure sensor 120 is contactable from the outside of the cavity package 110 via the leadframe 116. In other words, the cavity package 110 includes at least one terminal that is contactable from the outside of the cavity package 110. The terminal may, e.g., be configured to provide (output) an output signal of the pressure sensor 120. The output signal is an electrical signal generated by the pressure sensor 120 in response to the pressure within the first material 130 caused by the external force F applied to the second material 140. This output signal represents the measured pressure. The output signal may be an analog or digital representation of the pressure measurement. It may take the form of a voltage, current, frequency or capacitance change, depending on the type of pressure sensor used (e.g., capacitive, piezoelectric). It should be noted that other types of terminals may be used instead of the leadframe 116. In particular, the terminal may be configured to accommodate various types of connections, such as pins, pads, or plug-style contacts, enabling adaptability to different applications and integration requirements. The terminal enables direct access to the output signal of the pressure sensor 120 without requiring disassembly of the cavity package 110. This simplifies integration into sensor systems or external systems, such as controllers or signal processing units.

In some examples, the apparatus may optionally further comprise processing circuitry configured to determine a measurement value for the external force F based on the output signal of the pressure sensor 120. For example, the processing circuitry may be a single dedicated processor, a single shared processor, or a plurality of individual processors, some of which or all of which may be shared, a digital signal processor (DSP) hardware, an application specific integrated circuit (ASIC), a system-on-a-chip (SoC) a neuromorphic processor or a field programmable gate array (FPGA). The processing circuitry may optionally be coupled to, e.g., memory such as read only memory (ROM) for storing software, random access memory (RAM) and/or non-volatile memory. For example, the apparatus may comprise memory configured to store instructions, which when executed by the processing circuitry, cause the processing circuitry to perform the steps and methods described herein. For example, the processing circuitry may be configured to determine a measurement value for the external force F using a predetermined mathematical expression or relation that receives the pressure measured by the pressure sensor 120 (and as indicated by the output signal of the pressure) as input. The processing circuitry may be configured to determine a measurement value for the external force F using a linear mathematical expression or relation that receives the pressure measured by the pressure sensor 120 as input. Optionally, the processing circuitry may perform further signal processing on the output signal of the pressure sensor 120 such as signal amplification, filtering, temperature compensation, or calibration adjustments to ensure accurate and reliable results.

In other examples, the processing circuitry may be configured to generate a binary decision signal based on the output signal of the pressure sensor 120. The binary decision signal serves as a digital output indicating one of two possible states, such as “on/off,” “activated/inactivated,” or “threshold met/not met.” This functionality allows the apparatus to provide actionable feedback based on the pressure measurement. In other words, the processing circuitry may interpret the (raw) output signal from the pressure sensor 120 and convert it into a binary signal. This conversion may involve comparing the output signal to one or more predefined thresholds or ranges. The specific implementation may vary depending on the application. The conversion to a binary decision signal may be used in applications requiring straightforward decision-making, such as touch controls (e.g., activating a device or input signal when a button is pressed with sufficient force), safety systems (e.g., triggering alarms or shutdowns when a force exceeds a critical limit), industrial automation (e.g., detecting whether a load or pressure is present in a machine or process) or medical devices (e.g., indicating whether a certain pressure threshold, such as in infusion pumps or monitoring systems, has been met).

The processing circuitry may be arranged within or outside the cavity package 110. FIG. 2 illustrates an example apparatus 200 for force measurement in which the processing circuitry is arranged within the cavity package 110. In the following only the differences between the apparatuses 100 and 200 will be described for reasons of simplicity.

The apparatus 200 comprises a semiconductor chip 150 arranged in the cavity package 110. For example, the semiconductor chip 150 may be arranged (formed) on the base 111 of the cavity package 110. The semiconductor chip 150 comprises (holds) the pressure sensor 120 and the processing circuitry 160. The integration of the pressure sensor and processing circuitry into a single chip reduces the size of the apparatus 200, making it highly suitable for space-constrained applications, such as automotive interiors or wearable devices. On-chip integration minimizes the need for external connections between the pressure sensor 120 and processing circuitry 160. This reduces potential noise or signal degradation, ensuring accurate and reliable measurements. Combining the pressure sensor 120 and processing circuitry 160 on the same semiconductor chip 150 reduces the complexity of manufacturing, as fewer components need to be assembled. This streamlines production and lowers costs. Like the apparatus 100, the apparatus 200 comprises the leadframe 116 as an example structure for contacting the pressure sensor 120 and/or processing circuitry 160 from the outside of the cavity package 110. In other words, also cavity package 110 of the apparatus 200 may comprise at least one terminal that is contactable from the outside of the cavity package 110. The terminal may, e.g., be configured to provide (output) an output signal of the processing circuitry 160. The output signal of the processing circuitry 160 may represent the determined measurement value for the external force F or be the binary decision signal described above.

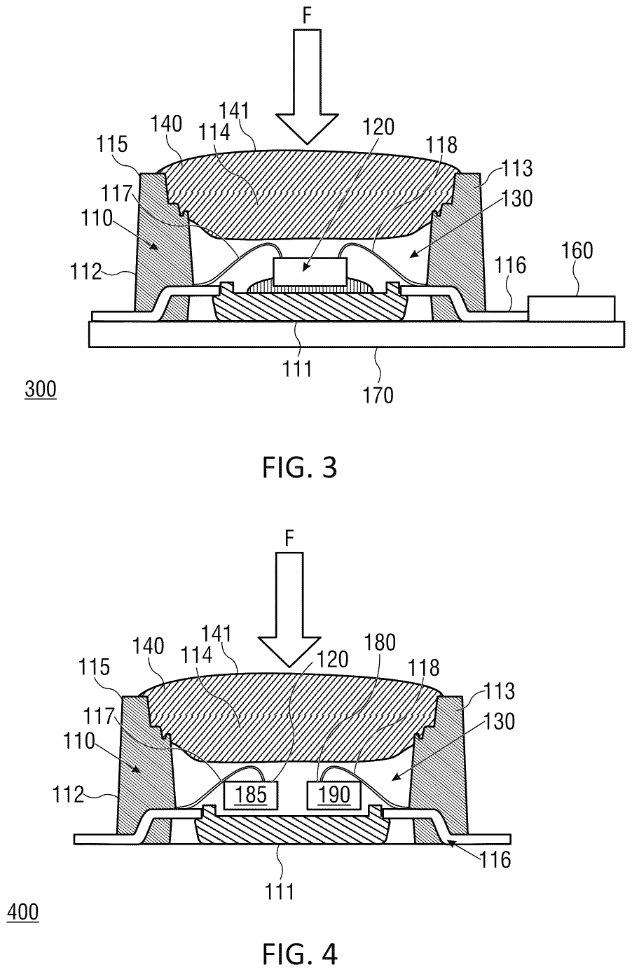

FIG. 3 illustrates an alternative example apparatus 300 for force measurement in which the processing circuitry 160 is arranged outside the cavity package 110. In the following only the differences between the apparatus 300 and the apparatuses 100 and 200 will be described for reasons of simplicity.

The apparatus 300 additionally comprises a substrate 170. The cavity package 110 is mounted on the substrate 170. The processing circuitry 160 is formed (mounted) on the substrate 170 outside of the cavity package 110. The substrate is a structural base that provides mechanical support for the cavity package 110 and the processing circuitry 160. The substrate 110 may be or be made from a rigid or semi-rigid material such as ceramic, silicon, Printed Circuit Board (PCB) or metal core or metal-backed substrates for enhanced thermal dissipation. For example, the processing circuitry 160 may be coupled to the terminal of the cavity package 110 providing the output signal of the pressure sensor 120 (depicted as a terminal of the leadframe 116 in FIG. 3).

By offloading the processing circuitry 160 to the substrate 170, the cavity package design is simplified, reducing its manufacturing complexity and potential failure points. Processing circuitry on the substrate 170 is easier to access for maintenance, troubleshooting, or upgrades compared to circuitry enclosed within the cavity package 110.

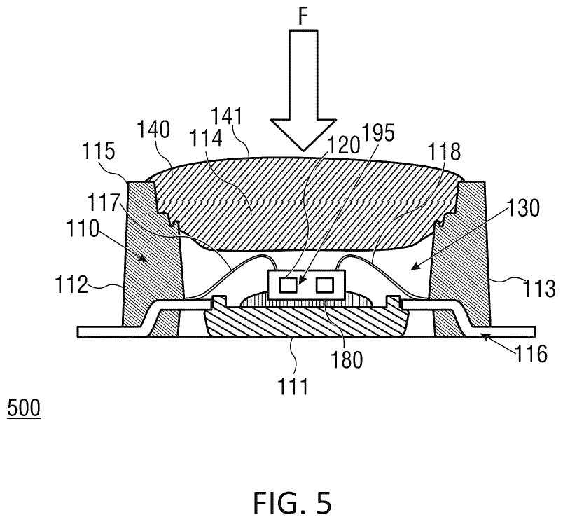

In the foregoing examples, a single pressure sensor is arranged within the cavity package. However, it should be noted that the present disclosure is not limited thereto. In general, plural pressure sensors may be arranged within the cavity package. The plural pressure sensors may be configured to measure different pressure ranges. By incorporating multiples sensors with different sensitivities, the apparatus may measure forces across a broader range than a single sensor, enhancing versatility. Two example apparatuses comprising two sensors with different sensitivities will be described in the following in greater detail with reference to FIGS. 4 and 5.

FIG. 4 illustrates another apparatus 400 for force measurement. In comparison to the apparatuses 100, 200 and 300 described above, the apparatus 400 further comprises a second pressure sensor 180 arranged within the cavity package 110. Like the (first) pressure sensor 120, the second pressure sensor 180 is enclosed by the first material 130. For example, both pressure sensors 120 and 180 may be arranged (formed) on the base 111 of the cavity package 110.

The pressure sensor 120 and the second pressure sensor 180 are configured to measure different pressure ranges. In other words, both pressure sensors 120 and 180 are configured to operate effectively within distinct ranges of pressure. Each sensor is tailored to provide accurate and reliable measurements within its respective range, which is determined by factors such as sensitivity, resolution, and durability. For example, the pressure sensor 120 may be configured for low-pressure ranges with high sensitivity and the second pressure sensor 180 may be configured for higher-pressure ranges with greater robustness. The pressure ranges of the pressure sensors 120 and 180 may partially overlap, but need not. For example, the pressure ranges of the pressure sensors 120 and 180 may be adjacent to each other.

The different sensitivities of the pressure sensors 120 and 180 allow the apparatus 400 to dynamically cover varying force levels without compromising accuracy or durability. Each sensor operates within its optimal pressure range, minimizing errors and ensuring precise measurements, even at extreme ends of the spectrum.

The output signal of the pressure sensors 120 and 180 may be provided at terminals of the cavity package that are contactable from the outside of the cavity package 110 - analogously to what is described above. Optionally, the apparatus 400 may comprise processing circuitry configured to determine a measurement value for the external force F based on the output signals of the pressure sensors 120 and 180. The processing circuitry may be arranged within or outside the cavity package 110—analogously to what is described above. For example, the processing circuitry may analyze the output signals of the pressure sensors 120 and 180 and select, based on the analysis, one of the output signals as input for the determination of the measurement value for the external force F. The processing circuitry may, e.g., determine if one of the pressure sensors 120 and 180 is in saturation and select the output signal of the non-saturated pressure sensor as input for the determination of the measurement value for the external force F.

In the example of FIG. 4, the pressure sensors 120 and 180 are separate physical devices. For example, each of the pressure sensors 120 and 180 may be formed in a separate semiconductor chip. In other words, the apparatus 400 may comprise a first semiconductor 185 chip and a separate second semiconductor chip 190 each arranged in the cavity package 110 (e.g., arranged or formed on the base 111 of the cavity package 110). The first semiconductor chip 185 comprises the pressure sensor 120 and the second semiconductor chip 190 comprises the second pressure sensor 180. Both semiconductor chips 185 and 190 are physically enclosed within the cavity package 110 and interact with the first material 130, which transfers pressure to both sensors. Each semiconductor chip is configured independently, allowing the pressure sensors 120 and 180 to be optimized for their respective pressure ranges without constraints imposed by shared integration on a single semiconductor chip. This architecture may be extended to include additional semiconductor chips and pressure sensors, enabling the apparatus 400 to cover an even broader range of pressures or support additional functionalities.

In case the apparatus 400 comprises processing circuitry arranged within the cavity package 110, the processing circuitry may be formed in one of the semiconductor chips 185 and 190. Alternatively, the processing circuitry may be formed in a separate third semiconductor chip arranged within the cavity package 110.

FIG. 5 illustrates an alternative apparatus 500 for force measurement. In comparison to the apparatus 400, the pressure sensor 120 and the second pressure sensor 180 are formed in a single semiconductor chip 195. In other words, the apparatus 500 comprises a semiconductor chip 195 arranged in in the cavity package 110 (e.g., arranged or formed on the base 111 of the cavity package 110), wherein the semiconductor chip 195 comprises the pressure sensor 120 and the second pressure sensor 180. The semiconductor chip 195 is enclosed within the cavity package 110 and protected by the first material 130 and the second material 140. Integrating both pressure sensors 120 and 180 on the same semiconductor chip 195 allows to reduce the physical size of the apparatus 500. This is particularly beneficial for applications where space constraints are critical, such as wearable devices or embedded automotive systems. Furthermore, the pressure sensors 120 and 180 may share common resources, such as power supply connections or terminals for external electrical connections.

The output signal of the pressure sensors 120 and 180 may be provided at terminals of the cavity package that are contactable from the outside of the cavity package 110—analogously to what is described above. Optionally, the apparatus 500 may comprise processing circuitry configured to determine a measurement value for the external force F based on the output signals of the pressure sensors 120 and 180. The processing circuitry may be arranged within or outside the cavity package 110—analogously to what is described above. In case the processing circuitry is arranged within the cavity package 110, the processing circuitry may be formed in the semiconductor chip 195. Alternatively, the processing circuitry may be formed in a separate second semiconductor chip arranged within the cavity package 110.

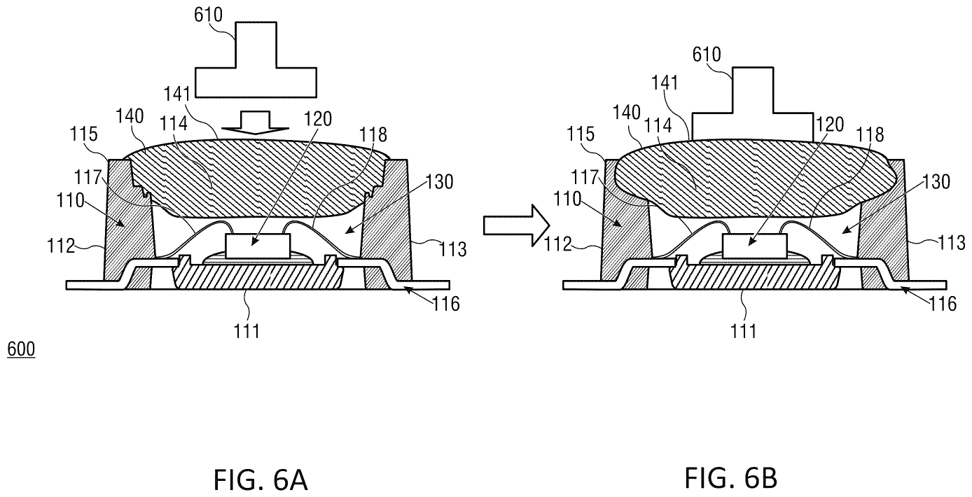

Optionally, the apparatuses described above may further comprise a pressable force applicator configured to apply the external force to the second material when pressed or pushed. The pressable force applicator is a structural component configured to receive an external input, such as a push or press, and transfer the applied force F to the second material 140. The force applicator serves as the point of contact between the external force source (e.g., a finger of a human being or a robot arm) and the apparatus, facilitating seamless interaction. This is exemplarily illustrated in FIGS. 6A and 6B showing another apparatus 600 for force measurement. The apparatus 600 is based on the apparatus 100 described above and additionally comprises the pressable force applicator 610. When the pressable force applicator 610 is pressed or pushed, it applies the external force F to the second material 140.

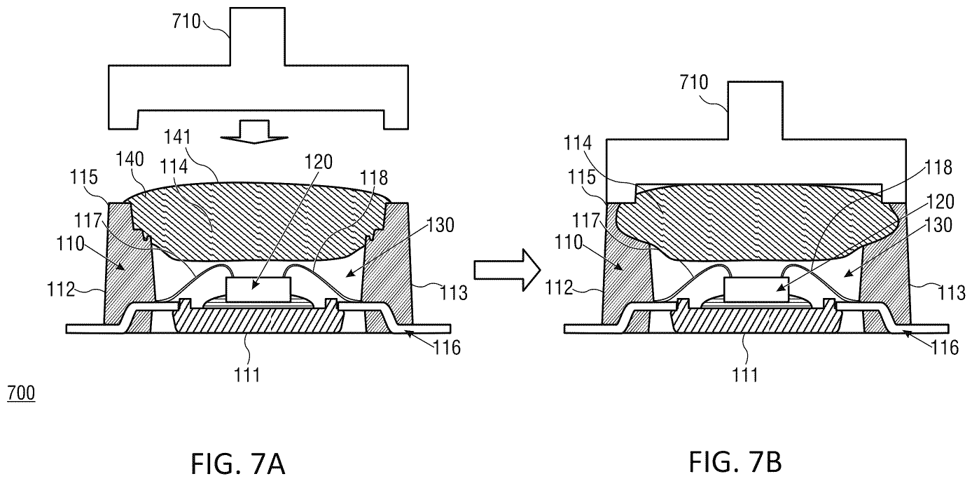

An alternative apparatus 700 for force measurement is illustrated in FIGS. 7A and 7B. Compared to the apparatus 600, the force applicator 710 and the cavity package 110 are configured to limit deformation of the first and second materials 130, 140 when the force applicator 710 is pressed or pushed. Particularly, the force applicator 710 is formed such that it comes into contact with the rim 115 of the cavity package 110 when the force applicator 710 is pressed or pushed beyond a predefined point, restricting the amount of deformation that the first and second materials 130 and 140 can undergo. This prevents the first and second materials 130 and 140 from being over-compressed or damaged by excessive force.

The apparatuses 200, 300, 400 and 500 may optionally further comprise the force applicators 610 and 710 shown in FIGS. 6A, 6B and 7A, 7B.

The apparatuses for force measurement described herein are versatile and suitable for use across a variety of fields due to its compact design, high sensitivity, and ability to handle a broad range of forces. In the automotive industry, an apparatus for force measurement as described herein may be integrated into systems such as touch-sensitive controls, push buttons, impact sensors, and parking assistance systems, where precise force or pressure measurement is critical. In industrial applications, an apparatus for force measurement as described herein may be employed for load and compression sensing, robotic end-effectors, variable tension control, and equipment monitoring, offering robust performance in demanding environments. An apparatus for force measurement as described herein is also valuable in medical devices, such as infusion pumps, diagnostic tools, and non-invasive monitoring systems, where accuracy and reliability are paramount. Additionally, in consumer electronics, an apparatus for force measurement as described herein may be utilized in weight measurement devices, touch panels, and interactive interfaces, enabling enhanced user experience. This adaptability makes the apparatuses for force measurement described herein a versatile solution for numerous applications requiring precise and durable force measurement.

Although specific examples have been illustrated and described herein, it will be appreciated by those of ordinary skill in the art that a variety of alternate and/or equivalent implementations may be substituted for the specific examples shown and described without departing from the scope of the present implementation. This application is intended to cover any adaptations or variations of the specific examples discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

### ASPECTS

The following provides an overview of some Aspects of the present disclosure:
Aspect 1: An apparatus for force measurement, the apparatus comprising: a cavity package; a pressure sensor arranged in the cavity package; and a first material and a second material arranged in the cavity package, wherein the first material encloses the pressure sensor, wherein the second material covers the first material, exhibits a higher Young's modulus than the first material, and is configured to transfer an external force applied to the second material to the first material, and wherein the pressure sensor is configured to measure pressure within the first material resulting from the external force.
Aspect 2: The apparatus of Aspect 1, wherein the first material and the second material are both gels.
Aspect 3: The apparatus of any of Aspects 1-2, wherein the first material is a fluid, and wherein the second material is a gel.
Aspect 4: The apparatus of any of Aspects 1-3, wherein the pressure sensor is a micromachined pressure sensor.
Aspect 5: The apparatus of any of Aspects 1-4, wherein the pressure sensor is a capacitive pressure sensor.
Aspect 6: The apparatus of any of Aspects 1-5, wherein the second material exhibits a Young's modulus of at least twice that of the first material.
Aspect 7: The apparatus of any of Aspects 1-6, wherein the second material forms a convex surface extending above a rim of the cavity package.
Aspect 8: The apparatus of any of Aspects 1-7, wherein the second material forms a flat surface that is substantially level with a rim of the cavity package.
Aspect 9: The apparatus of any of Aspects 1-8, wherein the second material forms a concave surface that dips below a rim of the cavity package.
Aspect 10: The apparatus of any of Aspects 1-9, wherein the first material forms a convex surface that is entirely covered by the second material.
Aspect 11: The apparatus of any of Aspects 1-10, wherein the first material is configured to create an isotropic pressure distribution within its volume when the external force is applied.
Aspect 12: The apparatus of any of Aspects 1-11, further comprising a second pressure sensor arranged within the cavity package and enclosed by the first material, wherein the pressure sensor and the second pressure sensor are configured to measure different pressure ranges.
Aspect 13: The apparatus of Aspect 12, further comprising a semiconductor chip arranged in the cavity package, wherein the semiconductor chip comprises the pressure sensor and the second pressure sensor.
Aspect 14: The apparatus of Aspect 12, further comprising a first semiconductor chip and a second semiconductor chip each arranged in the cavity package, wherein the first semiconductor chip comprises the pressure sensor and the second semiconductor chip comprises the second pressure sensor.
Aspect 15: The apparatus of any of Aspects 1-14, wherein the cavity package includes a terminal that is contactable from an outside of the cavity package, the terminal being configured to provide an output signal of the pressure sensor.
Aspect 16: The apparatus of any of Aspects 1-15, further comprising processing circuitry configured to determine a measurement value for the external force based on an output signal of the pressure sensor.
Aspect 17: The apparatus of Aspect 16, further comprising a semiconductor chip arranged in the cavity package, wherein the semiconductor chip comprises the pressure sensor and the processing circuitry.
Aspect 18: The apparatus of Aspect 16, further comprising a substrate, wherein the cavity package is mounted on the substrate, and wherein the processing circuitry is formed on the substrate outside of the cavity package.
Aspect 19: The apparatus of any of Aspects 1-18, further comprising a pressable force applicator configured to apply the external force to the second material when pressed.
Aspect 20: The apparatus of Aspect 19, wherein the pressable force applicator and the cavity package are configured to limit deformation of the first and second materials when the force applicator is pressed.
Aspect 21: A system configured to perform one or more operations recited in one or more of Aspects 1-20.
Aspect 22: An apparatus comprising means for performing one or more operations recited in one or more of Aspects 1-20.

1. An apparatus for force measurement, the apparatus comprising:
a cavity package;
a pressure sensor arranged in the cavity package; and
a first material and a second material arranged in the cavity package,
wherein the first material encloses the pressure sensor,
wherein the second material covers the first material exhibits a higher Young's modulus than the first material and is configured to transfer an external force applied to the second material to the first material and
wherein the pressure sensor is configured to measure pressure within the first material resulting from the external force.

2. The apparatus of claim 1, wherein the first material and the second material are both gels.

3. The apparatus of claim 1, wherein the first material is a fluid, and wherein the second material is a gel.

4. The apparatus of claim 1, wherein the pressure sensor is a micromachined pressure sensor.

5. The apparatus of claim 1, wherein the pressure sensor is a capacitive pressure sensor.

6. The apparatus of claim 1, wherein the second material exhibits a Young's modulus of at least twice that of the first material.

7. The apparatus of claim 1, wherein the second material forms a convex surface extending above a rim of the cavity package.

8. The apparatus of claim 1, wherein the second material forms a flat surface that is substantially level with a rim of the cavity package.

9. The apparatus of claim 1, wherein the second material forms a concave surface that dips below a rim of the cavity package.

10. The apparatus of claim 1, wherein the first material forms a convex surface that is entirely covered by the second material.

11. The apparatus of claim 1, wherein the first material is configured to create an isotropic pressure distribution within its volume when the external force is applied.

12. The apparatus of claim 1, further comprising a second pressure sensor arranged within the cavity package and enclosed by the first material wherein the pressure sensor and the second pressure sensor are configured to measure different pressure ranges.

13. The apparatus of claim 12, further comprising a semiconductor chip arranged in the cavity package wherein the semiconductor chip comprises the pressure sensor and the second pressure sensor.

14. The apparatus of claim 12, further comprising a first semiconductor chip and a second semiconductor chip each arranged in the cavity package wherein the first semiconductor chip comprises the pressure sensor and the second semiconductor chip comprises the second pressure sensor.

15. The apparatus of claim 1, wherein the cavity package includes a terminal that is contactable from an outside of the cavity package the terminal being configured to provide an output signal of the pressure sensor.

16. The apparatus of claim 1, further comprising processing circuitry configured to determine a measurement value for the external force based on an output signal of the pressure sensor.

17. The apparatus of claim 16, further comprising a semiconductor chip arranged in the cavity package wherein the semiconductor chip comprises the pressure sensor and the processing circuitry.

18. The apparatus of claim 16, further comprising a substrate, wherein the cavity package is mounted on the substrate, and wherein the processing circuitry is formed on the substrate outside of the cavity package.

19. The apparatus of claim 1, further comprising a pressable force applicator configured to apply the external force to the second material when pressed.

20. The apparatus of claim 19, wherein the pressable force applicator and the cavity package are configured to limit deformation of the first and second materials when the force applicator is pressed.
